(19) United States
(12) Patent Application Publication
(10) Pub. No.: US 2016/0354918 A1
(43) Pub. Date: Dec. 8, 2016

(54) TOOL WITH TWO INTERCHANGEABLE WORK ENDS

(71) Applicant: Compass Corporation, Tainan City (TW)

(72) Inventor: Tzu-Chien Wang, Tainan City (TW)

(21) Appl. No.: 14/733,297

(22) Filed: Jun. 8, 2015

(51) Int. Cl. B25G 3/22; B25B 23/00; B25B 15/00; B25D 5/00; B25C 9/00

(52) U.S. Cl. CPC B25G 3/22; B25D 5/00; B25C 9/00; B25B 15/001; B25B 23/0035

(57) ABSTRACT

A tool includes a main rod including a front end with a receptacle having an opening. The receptacle further includes a coupling section, a receiving section, and a shoulder between the coupling section and the receiving section. A work rod includes first and second work sections respectively having first and second work ends of different sizes. An insertion section between the first and second work sections includes first and second stop faces. One of the first and second work sections of the work rod is selectively inserted into the receiving section of the receptacle and is positioned by a positioning device. The insertion section is received in the coupling section. The other of the first and second work sections is exposed. One of the first and second stop faces abuts the shoulder of the receptacle to form a path for a force transmitted in an axial direction.

### BACKGROUND OF THE INVENTION

The present invention relates to a tool with interchangeable work ends and, more particularly, to a tool including two work ends that can be interchanged according to need while providing enhanced operational stability.

A conventional nail set, a center punch, or a screwdriver generally includes an elongated body having a front end serving as a work end. For example, a nail set includes a front end in the form of a work end for matching with a nail head. The other end of the nail set servers as a hammer end. In use, a user holds a holding portion between the hammer end and the work end, abuts the work end against a nail head, and hammers the hammer end to drive the nail head into a work-piece. A center punch has a structure similar to a nail head and includes a work end with a pointed section for generating a recess in a surface of a work-piece, permitting subsequent hole drilling operation by a drill. A screwdriver includes a work end with a keystone tip, a Phillips head tip, or a polygonal tip. A user can hold a handle portion of the screwdriver for driving a screw.

The size of the work end of the above-mentioned nail set, center punch, and screwdriver is fixed and, thus, provides poor applicability. Taking the nail set as an example, U.S. Pat. No. 8,359,950 discloses a nail set including a body portion and a tool portion. The body portion includes an opening formed therein. The tool portion includes a first work portion at one end portion thereof, and a second work portion at an opposite end portion thereof. The tool portion includes an outwardly extending shoulder portion. The first work portion or the second work portion can be selected to be inserted into the opening. The shoulder portion presses against an outer end face of the body portion to provide a path for a force transmitted from the body when the tool portion is disposed in the body portion and the body portion is impacted by a tool.

### BRIEF SUMMARY OF THE INVENTION

An objective of the present invention is to provide a tool including two work ends that can be interchanged according to need while providing enhanced operational stability.

A tool according to the present invention includes a main rod including a front end having a receptacle extending in an axial direction. The main rod further includes a holding portion on an outer side thereof. The receptacle includes an opening in the front end. The receptacle further includes a coupling section extending rearwards from the opening in the axial direction. The receptacle further includes a receiving section extending rearwards from the coupling section in the axial direction. A shoulder is formed between the coupling section and the receiving section. An inner diameter of the shoulder is smaller than an inner diameter of the coupling section. A work rod includes first and second work sections respectively on two ends thereof. The first work section includes a first work end. The second work section includes a second work end having a size different from a size of the first work end. The work rod further includes an insertion section between the first and second work sections. The insertion section has a maximum diameter larger than diameters of the first and second work sections. The insertion section includes a first stop face facing the first work section and a second stop face facing the second work section. The maximum diameter of the insertion section is slightly smaller than the inner diameter of the coupling section of the main rod. The coupling section prevents rotation of the work rod while the work rod is being inserted into the coupling section. Each of the first and second work sections has a length in the axial direction smaller than a length of the receiving section of the main rod in the axial direction. A positioning device is configured to position the work rod relative to the main rod.

One of the first and second work sections of the work rod is selectively inserted into the receptacle of the main rod and is positioned by the positioning device, the one of the first and second work sections of the work rod is received in the receiving section. The insertion section of the work rod is received in the coupling section. The other of the first and second work sections of the work rod is exposed. One of the first and second stop faces abuts the shoulder of the receptacle to form a path for a force transmitted in the axial direction.

Each of the coupling section of the receptacle of the main rod and the insertion section of the work rod can be polygonal.

The insertion section can have a length in the axial direction larger than the length of the coupling section in the axial direction.

The positioning device can be provided on the work rod. The positioning device is received in the coupling section of the receptacle when the work rod engages with the main rod.

The insertion section of the work rod can include a radial hole having an opening. A diameter of the opening of the radial hole is lightly smaller than an inner diameter of the radial hole. The positioning device includes a spring and a ball. The spring and the ball are received in the radial hole. The ball is biased by the spring to partially protrude outside of the opening of the radial hole.

In an example, each of the first and second work ends of the work rod can have a shape corresponding to a nail head.

In another example, each of the first and second work ends of the work rod has a pointed shape.

In a further example, each of the first and second work ends of the work rod has a keystone tip, a Phillips head tip, or a polygonal tip.

The insertion section of the work rod can further include a first and second recessed sections. The first recessed section is located between the positioning device and the first stop face. The second recessed section is located between the positioning device and the second stop face. One of the second and first recessed sections is exposed outside of the main rod when one of the first and second work sections is received in the receiving section of the receptacle of the main rod.

The present invention will become clearer in light of the following detailed description of illustrative embodiments of this invention described in connection with the drawings.

### DESCRIPTION OF THE DRAWINGS

FIG. 1 is an exploded, perspective view of a tool according to the present invention, illustrating a first example of a main rod and a work rod of the tool.

FIG. 2 is a perspective view of the tool of FIG. 1.

FIG. 3 is a cross sectional view of the tool of FIG. 2, with the work rod of the tool in a first engagement state.

FIG. 4 is a cross sectional view similar to FIG. 3, with the work rod in a second engagement state.

FIG. 5 is a perspective view of another example of the work rod according to the present invention.

FIG. 6 is a perspective view of a further example of the work rod according to the present invention.

### DETAILED DESCRIPTION OF THE INVENTION

In the examples of the present invention, like elements are designated by like reference numbers.

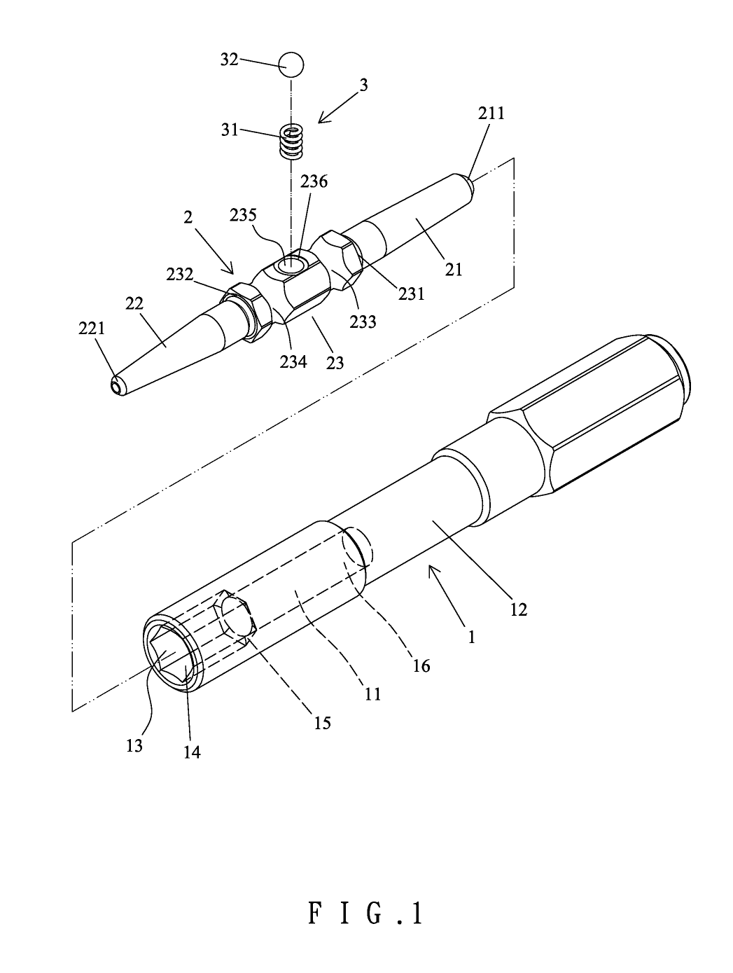

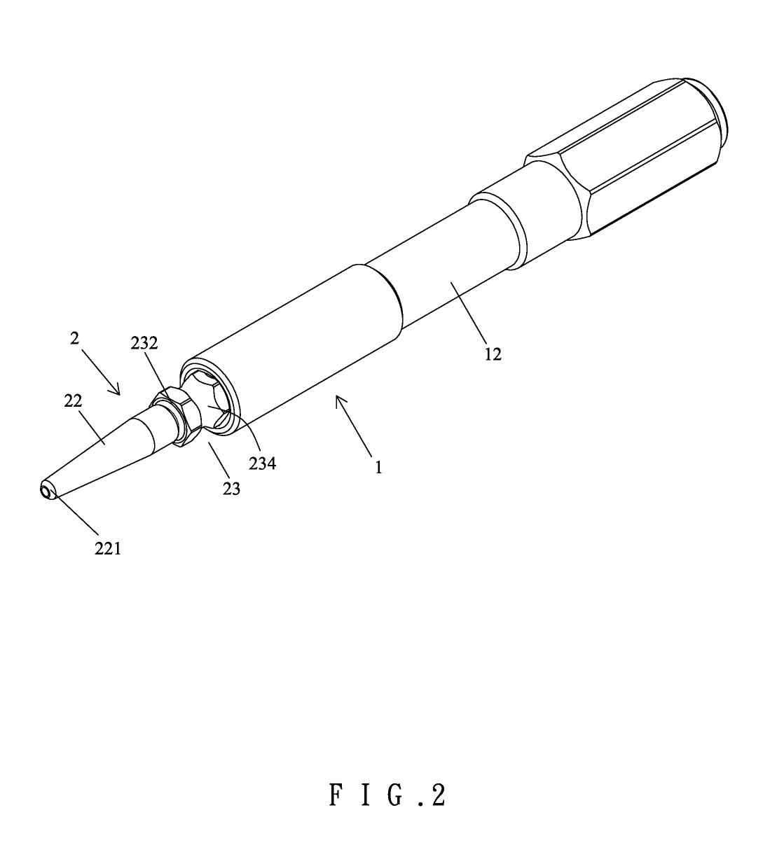

With reference to FIGS. 1-3, a tool of a first example according to the present invention includes a main rod 1 and a work rod 2. The main rod 1 is elongated. The main rod 1 includes a front end having a receptacle 11 extending in an axial direction. The main rod 1 further includes a holding portion 12 on an outer side thereof. The receptacle 11 includes an opening 13 in the front end. The receptacle 11 further includes a coupling section 14 extending rearwards from the opening 13 in the axial direction. The coupling section 14 is polygonal. The receptacle 11 further includes a receiving section 16 extending rearwards from the coupling section 14 in the axial direction. A shoulder 15 is formed between the coupling section 14 and the receiving section 16. An inner diameter of the shoulder 15 is smaller than an inner diameter of the coupling section 14.

The work rod 2 is elongated. The work rod 2 includes first and second work sections 21 and 22 respectively on two ends thereof. The first work section 21 includes a first work end 211. The second work section 22 includes a second work end 221 having a size different from a size of the first work end 211. In this example, each of the first and second work ends 211 and 221 of the work rod 2 has a shape corresponding to a nail head. The work rod 2 further includes an insertion section 23 between the first and second work sections 21 and 22. The insertion section 23 has a maximum diameter larger than diameters of the first and second work sections 21 and 22. The insertion section 23 further includes a first stop face 231 facing the first work section 21 and a second stop face 232 facing the second work section 22. The insertion section 23 is polygonal and has a shape corresponding to the coupling section 14 of the main rod 1. The maximum diameter of the insertion section 23 is slightly smaller than the inner diameter of the coupling section 14 of the main rod 1. The insertion section 23 has a length in the axial direction larger than the length of the coupling section 14 in the axial direction. Each of the first and second work sections 21 and 22 has a length in the axial direction smaller than a length of the receiving section 16 of the main rod 1 in the axial direction.

The insertion section 23 further includes first and second recessed sections 233 and 234. A user can grip the first recessed section 233 or the second recessed section 234. In this example, the first recessed section 233 is located between the positioning device 3 and the first stop face 231. The second recessed section 234 is located between the positioning device 3 and the second stop face 232.

The positioning device 3 is provided on the work rod 2. The positioning device 3 is received in the coupling section 14 of the receptacle 11 when the work rod 2 engages with the main rod 1. The insertion section 23 of the work rod 2 further includes a radial hole 235 having an opening 236. A diameter of the opening 236 of the radial hole 235 is lightly smaller than an inner diameter of the radial hole 235. The positioning device 3 includes a spring 31 and a ball 32. The spring 31 and the ball 32 are received in the radial hole 235. The ball 32 is biased by the spring 31 to partially protrude outside of the opening 236 of the radial hole 235.

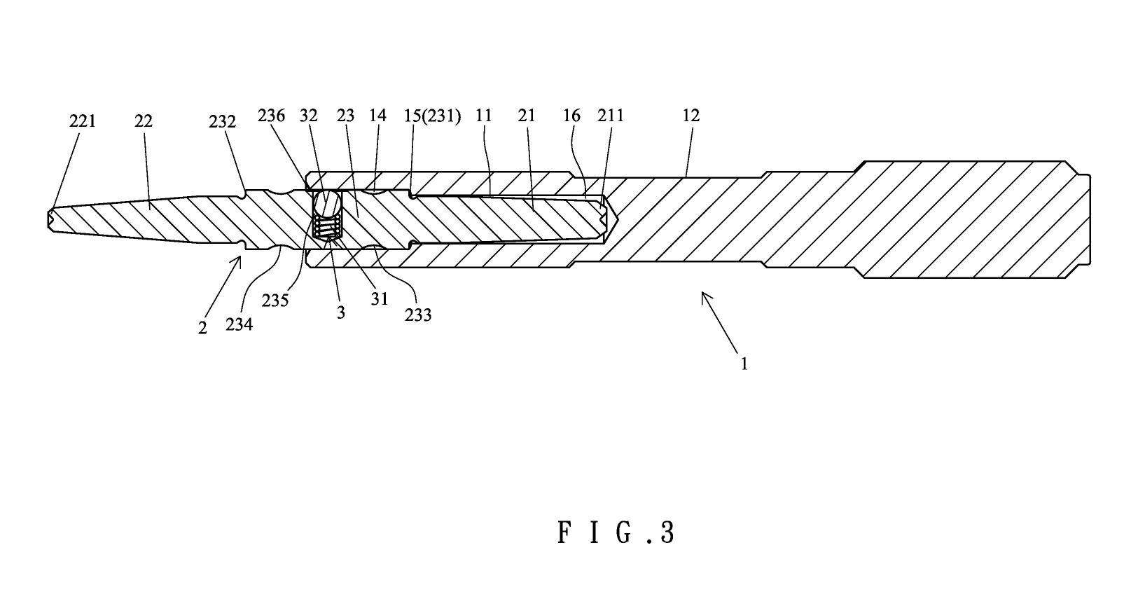

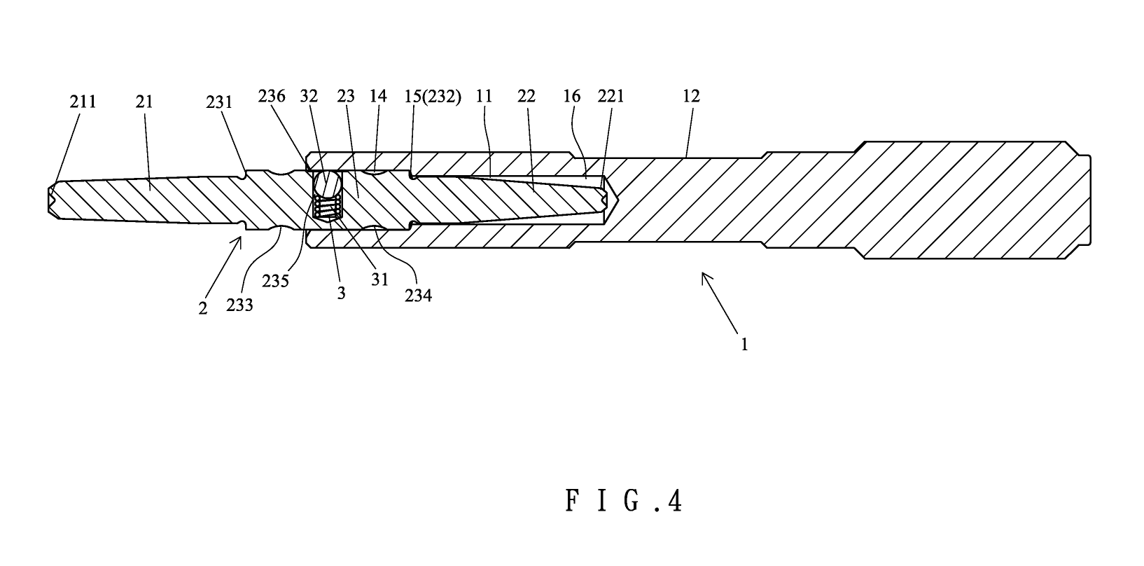

With reference to FIGS. 3 and 4, one of the first and second work sections 21 and 22 of the work rod 2 is selectively inserted into the receptacle 11 of the main rod 1 and is positioned by the positioning device 3. The first work section 21 (FIG. 3) or the second work section 22 (FIG. 4) of the work rod 2 is received in the receiving section 16. The insertion section 23 of the work rod 2 is received in the coupling section 14. The other of the first and second work sections 21 and 22 of the work rod 2 is exposed. Furthermore, one of the second and first recessed sections 234 and 233 is exposed outside of the main rod 1 when one of the first and second work sections 21 and 22 is received in the receiving section 16 of the receptacle 11 of the main rod 1. Furthermore, one of the first and second stop faces 231 and 232 abuts the shoulder 15 of the receptacle 11 to form a path for force transmitted in the axial direction. The ball 32 of the positioning device 3 presses against an inner wall of the coupling section 14 of the receptacle 11. The receiving section 14 receives a portion of the insertion section 23. The polygonal shapes of the insertion section 23 and the coupling section 14 prevent rotation of the work rod 2 while the work rod 2 is being inserted into the coupling section 14.

The combination of the main rod 1 and the work rod 2 according to the present invention provides the first and second work ends 211 and 221 of two different sizes, providing better application. Furthermore, the shoulder 15 of the main rod 1 is inside the receptacle 11 and is, thus, prevented from disfiguration due to impact (such as impact resulting from falling or impact by an external object other than the work rod 2). Furthermore, the hand of the user holding the holding portion 12 of the main rod 1 will not touch the positioning device 3, assuring stable positioning between the work rod 2 and the main rod 1. Furthermore, the user can use the fingers to hook the first recessed portion 233 or the second recessed portion 234 to easily remove the work rod 2 out of the main rod 1.

When the first work end 211 or the second work end 221 engages with a head of a nail (not shown), a striking force can be applied to the main rod 1 by hammering the rear end of the main rod 1. Since the shoulder 15 presses against the first stop face 231 or the second stop face 232 and since the coupling section 14 engages with the insertion section 23, an axial force imparted to the work rod 2 will not deviate from the axial direction. Thus, the nail subject to the axial force will not deviate, providing better operation.

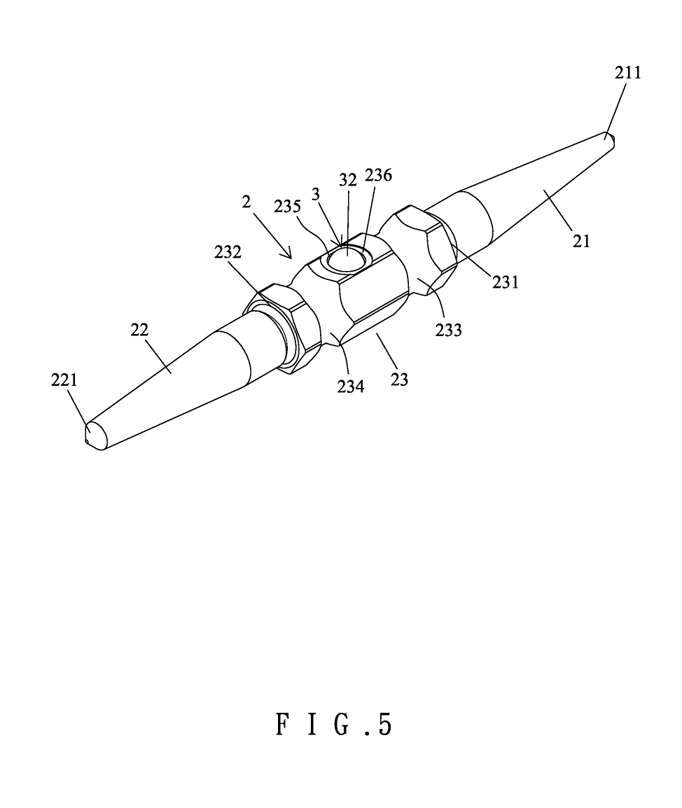

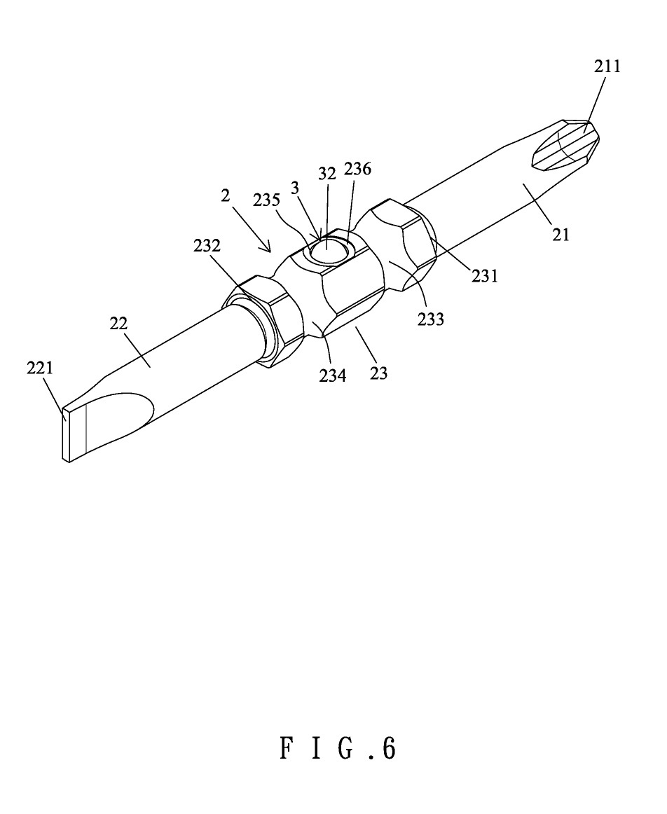

The first and second work ends 211 and 221 of the work rod 2 can be of other forms. In an example shown in FIG. 5, each of the first and second work ends 211 and 221 of the work rod 2 can have a pointed shape. In another example, each of the first and second work ends 211 and 221 of the work rod 2 has a keystone tip, a Phillips head tip, or a polygonal tip (see FIG. 6).

The positioning device 3 can be mounted to another location other than the work rod 2 without adversely affecting the effect of preventing deviation of the axial force during operation.

Although specific embodiments have been illustrated and described, numerous modifications and variations are still possible without departing from the scope of the invention. The scope of the invention is limited by the accompanying claims.

1. A tool comprising:
a main rod including a front end having a receptacle extending in an axial direction, with the main rod further including a holding portion on an outer side thereof, with the receptacle including an opening in the front end, with the receptacle further including a coupling section extending rearwards from the opening in the axial direction, with the receptacle further including a receiving section extending rearwards from the coupling section in the axial direction, with a shoulder formed between the coupling section and the receiving section, with an inner diameter of the shoulder being smaller than an inner diameter of the coupling section;
a work rod including first and second work sections respectively on two ends thereof, with the first work section including a first work end, with the second work section including a second work end having a size different from a size of the first work end, with the work rod further including an insertion section between the first and second work sections, with the insertion section having a maximum diameter larger than diameters of the first and second work sections, with the insertion section including a first stop face facing the first work section and a second stop face facing the second work section, with the maximum diameter of the insertion section being slightly smaller than the inner diameter of the coupling section of the main rod, with the coupling section preventing rotation of the work rod while the work rod is being inserted into the coupling section, and with each of the first and second work sections having a length in the axial direction smaller than a length of the receiving section of the main rod in the axial direction; and
a positioning device configured to position the work rod relative to the main rod,
wherein one of the first and second work sections of the work rod is selectively inserted into the receptacle of the main rod and is positioned by the positioning device, the one of the first and second work sections of the work rod is received in the receiving section, the insertion section of the work rod is received in the coupling section, another of the first and second work sections of the work rod is exposed, and one of the first and second stop faces abuts the shoulder of the receptacle to form a path for a force transmitted in the axial direction.

2. The tool as claimed in claim 1, wherein each of the coupling section of the receptacle of the main rod and the insertion section of the work rod is polygonal.

3. The tool as claimed in claim 1, wherein the insertion section has a length in the axial direction larger than the length of the coupling section in the axial direction.

4. The tool as claimed in claim 1, wherein the positioning device is provided on the work rod, and wherein the positioning device is received in the coupling section of the receptacle when the work rod engages with the main rod.

5. The tool as claimed in claim 4, with the insertion section of the work rod including a radial hole having an opening, with a diameter of the opening of the radial hole being lightly smaller than an inner diameter of the radial hole, with the positioning device including a spring and a ball, with the spring and the ball received in the radial hole, and with the ball biased by the spring to partially protrude outside of the opening of the radial hole.

6. The tool as claimed in claim 1, wherein each of the first and second work ends of the work rod has a shape corresponding to a nail head.

7. The tool as claimed in claim 1, wherein each of the first and second work ends of the work rod has a pointed shape.

8. The tool as claimed in claim 1, wherein each of the first and second work ends of the work rod has a keystone tip, a Phillips head tip, or a polygonal tip.

9. The tool as claimed in claim 4, with the insertion section of the work rod further including a first and second recessed sections, with the first recessed section located between the positioning device and the first stop face, with the second recessed section located between the positioning device and the second stop face, and with one of the second and first recessed sections exposed outside of the main rod when one of the first and second work sections is received in the receiving section of the receptacle of the main rod.
